(19) United States
(12) Patent Application Publication
(10) Pub. No.: US 2016/0192643 A1
(43) Pub. Date: Jul. 7, 2016

(54) NEW ANTIFUNGAL COMPOSITION FOR TREATMENT OF SOIL

(71) Applicant: CERADIS B.V., Wageningen (NL)

(72) Inventors: Jacobus Stark, Wageningen (NL); Wilhelmus Maria van der Krieken, Wageningen (NL); Christiaan Gerardus Johannes Maria Jans, Wageningen (NL)

(21) Appl. No.: 14/916,420

(22) PCT Filed: Sep. 4, 2014
(86) PCT No.: PCT/NL2014/050607

§ 371 Date: Mar. 3, 2016

(30) Foreign Application Priority Data
Sep. 4, 2013 (EP) 13183027.5

(51) Int. Cl. A01N 25/24; A01N 43/90

(52) U.S. Cl. CPC A01N 25/24; A01N 43/90

(57) ABSTRACT

The invention relates to a soil comprising a complex of at least one antimicrobial compound and a polyelectrolyte complex of a polyanion and a polycation. The invention further relates to methods for treatment of a soil, methods for preventing the development of pathogenic soilborne microorganisms, in and/or on a soil, and to methods of preventing, reducing and/or eliminating the presence of fungi, bacteria and/or viruses in/on a soil. The invention further relates to a use of a complex of an antimicrobial compound and a polyelectrolyte complex for preventing, reducing and/or eliminating the presence of fungi, bacteria and/or viruses in/on a soil.

### FIELD

The present invention relates to the treatment of soil using a complex of at least one antimicrobial compound and a polyelectrolyte complex of a polyanion (such as lignosulfonate) and a polycation (such as chitosan).

### INTRODUCTION

Soil is an incredibly complex ecosystem due to the interactions between the wide variety of organisms existing within the soil. Soil contains many microorganisms which break down organic matter into nutrients for uptake by e.g. plants. One gram of soil may contain hundreds of different microbial species and millions of individual microorganisms. In a balanced soil ecosystem there will also be a balanced microflora contributing to the optimal growth of plants. A good natural diversity of different bacterial and fungal species plays an important role in the whole soil ecosystem and will guarantee a healthy soil and optimal development of plants.

However, soil is also a reservoir for many plant pathogens. Plants are under constant attack by microorganisms which live in or on the soil. These fungal, bacterial and viral pathogens can infect plants causing soilborne diseases. Under natural conditions there will mostly be a balance between the beneficial and pathogenic microflora. In agriculture, mostly a monoculture, soilborne diseases caused by fungal, bacterial or viral pathogens will develop much more easily. Clean and pathogen-free soil is therefore of enormous importance to prevent development of pathogens and thus prevent yield losses when growing crops.

Preventing the presence and/or growth of plantpathogenic microorganisms in/on the soil for crops is an important issue in agriculture, horticulture and mushroom cultivation.

Soilborne diseases are difficult to control because soilborne pathogens can survive for long periods in the soil. Especially fungal spores which play a main role in soilborne diseases are able to survive in soil for years in the absence of a plant host organism. In addition the majority of soilborne pathogens has a wide host range and sometimes causes different diseases on different hosts.

Soilborne pathogens can be moulds, yeast, bacteria or viruses. The most common soilborne pathogens are moulds. Moulds can cause root rot by infecting the plant roots and disturb the process of water and nutrient uptake. Examples of such mould species are Cylindrocladium, Armillaria, Pythium, Phytophthora and Rhizoctonia. Other moulds interact with the plant at ground level and cause rot of the stem and crown. Common pathogens in this respect are Phytophthora, Rhizoctonia, Sclerotinia and Sclerotium. Fusarium oxysporum and Verticillium species are examples of moulds which may cause wilting of the crop. Finally moulds such as Pythium, Phytophthora, Rhizoctonia and Sclerotium rolfsii may infect the germinating seed leading to death. Bacteria and viruses are far less common soilborne pathogens. Examples of bacteria are Erwinia species causing soft rot, Rhizomonas species causing corky root of e.g. lettuce and Streptomyces species causing soft rot of sweet potatoes.

A first example of a crop very susceptible to mould pathogens are mushrooms. Moulds may easily develop during cultivation of mushrooms. Since a mushroom is a mould, it is easy to understand that growth conditions maintained during commercial cultivation of mushrooms are also optimal for the development of unwanted moulds, including mushroom pathogens. Moulds cause severe problems in the mushroom industry resulting in lower yields. Main mushroom pathogens are Trichoderma species such as T. harzianum causing green mould disease, Verticillium species such as V. fungicola causing dry bubble disease and Mycogone pernicosa causing wet bubble disease. Other examples of harmful moulds which may occur in mushroom industry are Penicillium, Aspergilllus, Dactylium, Scopulariopsis and Fusarium species.

A second example of a crop susceptible to soilborne mould pathogens are potatoes and seed potatoes. This crop often suffers from Rhizoctonia solani, a fungus which attacks tubers and underground sprouts of the potato plant causing black scurf or sclerotia and different unnoticed underground diseases which later in the season result in illness and lower yields.

A third example of a crop susceptible to soilborne pathogens are bananas. Fusarium oxysporum f. sp cubense causes the so called Panama disease, the most important disease of banana plants. This mould is mainly spread through the soil and very aggressively attacks banana plants of all ages. One should be aware that F. oxysporum species are common soil organism which have the ability to survive and multiply under various environmental conditions; thus it can infect a wide host of crops all around the world such as potato, tomato, watermelon, strawberries, palm trees and beans.

A fourth example of a crop attacked by soilborne moulds are peanuts. Due to the close association with the soil this crop is more susceptible to soilborne pathogens. Prevention of soilborne diseases is every year a major concern for producers. The white mould Sclerotium rolfsi is a very destructive disease of peanut in the USA. Disease-related losses of 50 percent are not uncommon. Other soilborne pathogens on peanuts are Botrytis cinerea, Rhizoctonia solani and Verticillium species.

It is clear that soilborne pathogenic microorganisms, especially soilborne pathogenic moulds, cause many problems in agriculture, horticulture and mushroom industry. Mushrooms, bananas, potatoes and peanuts are just a few examples of crops suffering from soilborne pathogens. In fact soilborne diseases can occur on any crop.

Since most soilborne pathogens are moulds, combatting soilborne moulds is an important issue in agriculture, horticulture and mushroom cultivation.

A first example of an antifungal compound applied for combatting soilborne moulds is chlorothalonil which is widely used on many different crops. Its use is typically for, but not limited to, combatting fungal diseases of bananas, potatoes, peanuts, tomatoes, citrus fruit, coffee and onions. An example is the use of chlorothalonil in mushroom cultivation for the control of dry bubble disease caused by Verticillium fungicola. Examples of commercial products containing chlorothalonil are Bravo® 500-EC, Bravo® Ultrex and Bravo® Weather Stik (Syngenta Crop Protection, Inc.); other examples of trade names for products containing chlorothalonil are Bayer Chlorothalonil 500 SC (Bayer Cop Protection, Inc.), Echo® 720 (Sipcam Agro USA, Inc.), Daconil® 2787, Turf-Daconil® and Daconil® Weather Stick (Syngenta Crop Protection, Inc.), Nopcocide® n-96 or Tuffside® 960 (Gb biosciences cooperation).

A second example of an antifungal compound is thiophanate-methyl (dimethyl 4,4′-(o-phenylene)bis(3-thioallophanate)), a fungicide widely used in crop protection, active against e.g. Rhizoctonia diseases, cottony rot, Thielaviopsis rots and Cylindrocladium diseases. An example of a commercial trade name is Topsin® M 70WP (Cerexagri-Nisso LCC); an other example of a commercial brand is Senator® 70WP (ENGAGE Agro Cooperation). Said products can be applied in mushroom cultivation against Trichoderma species, treatment of turf areas such as golf course greens and for controlling moulds in the cultivation of many other crops such as potatoes, onions, sugarbeets, apples, pears, grapes, strawberries, greenhouse ornamentals and flowers.

A third example of a soil fungicide is fosetyl-aluminium or aluminum tris(ethyl phosponate), on the market as Aliette® (Bayer Crop Protection, Inc) which e.g. is being applied against Phytophtera and Pythium species in the cultivation of e.g. potatoes, seed-potatoes, strawberries and many other crops.

A fourth example of a fungicide which can be applied for soil treatment is N-[3-(1-methylethoxy)phenyl]-2-(trifluoromethyl)benzamide or flutonalil on the market under the trade name of e.g. Symphonie® and Monarch® (Belchim Crop Protection) and used for combatting soilborne moulds such as Rhizoctonia solani in potatoes and flower bulbs.

A fifth example of a fungicide which is widely used in agriculture and is being applied for soil treatment is iprodione (3-(3,5-dichlorophenyl)-N-isopropyl-2,4-dioxoimidazolidine-1-carboxamide), which is on the market as e.g. Rovral® or Chipco® Green (Bayer Crop Protection, Inc.).

A sixth example of a fungicide which is being applied for soil treatment is the soil fungicide pentachlornitrobenzene, on the market under the trade name Terraclor®. This soil fungicide is applied for control of e.g. Rhizoctonia solani, Sclerotinia spp. and Sclerotium rolfsii in a wide variety of crops such as potatoes, peanuts, cotton and vegetables.

A last example of a fungicide which is being applied for soil treatment is 2-(4′-thiazolyl)-benzimidazole, thiabendazole, e.g. on the market under the trade name Mertect® (Syngenta Crop Protection LLC). Thiabendazole is widely used, e.g. in mushroom cultivation against Verticillium fungicola, Mycogone perniciosa,

Dactylium dendroides and Trichoderma spp. It is further used e.g. against Fusarium rot on potatoes or flower bulbs and against Sclerotinia rot on carrots.

Due to more strict regulation in relation to environmental and human health issues several crop protection agents including fungicides are being banned or will no longer be approved in the near future. Further, both from an economical (lower production costs) and from an environmental point of view, there is a strong wish to reduce the dosage rates of the active ingredients which are applied nowadays. Another concern is the increased presence of soilborne pathogens which have developed resistance against the antimicrobials applied in crop protection. Another severe problem in combatting soilborne diseases is the need for pest control systems which combine an immediate activity with a long lasting action.

It can be concluded that there is a need for more effective compositions and methods for combatting pathogenic soilborne microorganisms, especially moulds, in agriculture, horticulture and mushroom cultivation.

### SUMMARY OF THE INVENTION

The invention provides a soil comprising a complex of at least one antimicrobial compound and a polyelectrolyte complex of a polyanion and a polycation, whereby the polyanion and the polycation are present in a relative amount of between 1:2 and 60:1 (w/w).

It was surprisingly found that the complexes of this invention, comprising of at least one antimicrobial compound and a polyelectrolyte complex, dramatically improved the antimicrobial effect of antimicrobial compounds such as natamycin against fungi, in comparison with an antimicrobial compound without said polyelectrolyte complex. Without being bound by theory, said polyelectrolyte complex may provide improved, longer lasting, adherence of the antimicrobial compound to the soil and/or the adherence to the microbe. Moreover it has been found that these complexes are very stable under aqueous conditions.

A polyelectrolyte complex of a polyanion and a polycation is an irreversible and insoluble complex. This complex alone does not have antimicrobial efficacy. The polyelectrolyte complex has sticky properties and contains polar parts (charged) and apolar parts. The aromatic moieties in the complex may have affinity for antimicrobial compounds such as, for example, natamycin. In combination with the sticky character of the polyelectrolyte complex, the antimicrobial compound will be optimally deposited and adhered to the soil for use in agriculture, horticulture and mushroom cultivation.

Said polyanion is preferably selected from the group consisting of a natural polyanion such as xanthan gum, alginate, a lignin compound such as lignosulfonate, pectin, carrageenan, humate, fulvate, angico gum, gum Kondagogu, sodium alkyl naphtalene sulfonate (Morwet), poly-γ-glutamic acid, maleic starch half-ester, carboxymethyl cellulose, chondroitin sulphate, dextran sulphate, hyaluronic acid and a synthetic polyanion such as poly(acrylic acid), polyphosphoric acid, and poly(L-lactide). Said polyanion most preferably is a lignin compound such as lignosulfonate.

Said polycation is preferably selected from the group consisting of poly-L-lysine, epsilon-poly-L-lysine, poly-L-arginine, poly-allylamine, chitosan oligosaccharide, and chitosan. Said polycation most preferably is chitosan.

Said at least one antimicrobial compound preferably is or comprises a fungicide, most preferably said at least one antimicrobial compound is a polyene antifungal compound, most preferably natamycin.

The soil preferably is a soil that is used in agriculture, horticulture or mushroom cultivation.

The invention further provides a method for treatment of a soil comprising a) providing an aqueous solution of a polyanion, wherein the concentration of said polyanion is from 0.1-60 w/v %, b) providing a polycation, c) adding the polycation to the polyanion solution, thereby forming a precipitate, d) crushing the formed precipitate to form an suspension, and e) adding the suspension to the soil, whereby at least one antimicrobial compound is added to the product of one of steps (a-d) prior to the addition of the suspension to the soil.

The invention further provides a method for preventing the development of pathogenic soilborne microorganisms which can cause diseases on crops, especially fungi, in and/or on a soil, the method comprising a) providing an aqueous solution of a polyanion, wherein the concentration of said polyanion is from 0.1-60 w/v %, b) providing a polycation, c) adding the polycation to the polyanion solution, thereby forming a precipitate, d) crushing the formed precipitate to form an suspension, and e) adding the suspension to the soil; whereby at least one antimicrobial compound is added to the product of one of steps (a-d) prior to the addition of the suspension to the soil.

The invention further provides a method of preventing, reducing and/or eliminating the presence of fungi, bacteria and/or viruses in/on soil, comprising a) providing an aqueous solution of a polyanion, wherein the concentration of said polyanion is from 0.1-60 w/v %, b) providing a polycation, c) adding the polycation to the polyanion solution, thereby forming a precipitate, d) crushing the formed precipitate to form an suspension, and e) adding the suspension to the soil; whereby at least one antimicrobial compound is added to the product of one of steps (a-d) prior to the addition of the suspension to the soil.

The term soil includes a substrate such as an artificial substrate and/or a growth substrate that is used in agriculture, horticulture or mushroom cultivation, such as a growth substrate for mushrooms.

It is preferred that the at least one antimicrobial compound in a method of the invention is or comprises a polyene fungicide, preferably natamycine.

The invention further provides the use of a complex of an antimicrobial compound and a polyelectrolyte complex of a polyanion and a polycation for preventing, reducing and/or eliminating the presence of fungi, bacteria and/or viruses in/on a soil.

### DETAILED DESCRIPTION

The present invention provides a soil comprising a complex of at least one antimicrobial compound and a polyelectrolyte complex of a polyanion and a polycation.

The term “polyelectrolyte” refers to a molecule consisting of a plurality of charged groups that are linked to a common backbone. In the context of this application, the term “polycation” is interchangeable with the term “positively charged polyelectrolyte” and the term “polyanion” is interchangeable with the term “negatively charged polyelectrolyte”.

The term “polyelectrolyte complex” refers to a complex of oppositely charged polyelectrolytes (a polyanion and a polycation) which form strong electrostatic links, thus avoiding the use of covalent cross-linkers. The complex is not soluble.

A preferred complex comprises an antimicrobial compound, preferably an antifungal compound, more preferably a polyene fungicide, most preferably natamycin, optionally at least one additional antimicrobial compound, and a polyelectrolyte complex between a polycation, preferably chitosan, and a polyanion, preferably lignosulfonate. In a watery solution at a pH of about 4.5, polycations such as chitosan polymers are positively charged and the cationic amino groups on the glucosamine subunits can interact electrostatically with anionic groups (usually sulfonic acid groups) of polyanions such as lignosulfonate to form polyelectrolyte complexes.

Without being bound by theory, it is thought that the addition of an antimicrobial compound to a polyelectrolyte complex results in the reversible binding of the antimicrobial compound to the polyelectrolyte complex, resulting in an improved, longer lasting, adherence of the antimicrobial compound to the soil. In addition, it is thought that the polyelectrolyte complex provides a slow, continuous release of the antimicrobial compound over time, thereby providing a longer lasting antimicrobial activity of the antimicrobial compound.

Said polyanion is preferably selected from the group consisting of a natural polyanion such as xanthan gum, alginate, a lignin compound such as lignosulfonate, pectin, carrageenan, humate, fulvate, angico gum, gum Kondagogu, sodium alkyl naphtalene sulfonate (Morwet), poly-γ-glutamic acid, maleic starch half-ester, carboxymethyl cellulose, chondroitin sulphate, dextran sulphate, hyaluronic acid and a synthetic polyanion such as poly(acrylic acid), polyphosphoric acid, and poly(L-lactide). Preferably, said polyanion is selected from the group consisting of xanthan gum, alginate, humate and lignosulfonate. A most preferred polyanion is or comprises a lignin compound such as lignosulfonate. Said polyanion may comprise two or more distinct polyanions such as, for example, xanthan gum and a lignin compound such as lignosulfonate or pectin and a lignin compound such as lignosulfonate.

The term “lignin compound” refers to a compound that is derived from naturally occurring lignin or lignen by a process that includes sulphonation. The resulting sulfonic acids are strong acids and lignin compounds are therefore negatively charged at pH values below 7.

A preferred lignin compound is selected from Kraft lignin, organosolv lignin and/or lignosulfonate.

A Kraft lignin is a polyphenolic product from the Kraft pulping process for the conversion of wood into wood pulp. Included are derivatives from Kraft lignin obtained by oxidation or other chemical modification as is known to the skilled person.

An organosolv lignin is a polyphenolic product from delignification processes using organic solvents. Included are derivatives from organosolv lignin obtained by oxidation or other chemical modification as is known to the skilled person.

Lignosulfonate (also termed lignosulphonate, lignosulfate, lignin sulfonate, ligninsulfonate, ligninsulfonic acid, lignosulfonic acid, lignosulfuric acid, or LST 7) is a water-soluble anionic polymer which is, for example, formed as a by-product in the sulphite pulping process. Lignosulfonates generally have a wide molecular weight distribution, typically in the range of about 500 to about 150,000. Lignosulfonates may comprise different metal or ammonium ions as counter cations of the sulfonate groups such as, for example, copper, zinc, calcium, sodium, potassium, magnesium and aluminium. Suitable examples of lignosulfonates comprise sodium lignosulfonate (e.g. sold as BORRESPERSE NA®, Borregaard LignoTech Ltd, Germany), calcium lignosulfonate (e.g. sold as BORRESPERSE CA®, Borregaard LignoTech Ltd, Germany), ammonium lignosulfonate, potassium lignosulfonate, modified lignosulfonate, derivatives of lignosulfonate, or mixtures thereof. Modified lignosulfonates, and derivatives of lignosulfonates are described in U.S. Pat. Nos. 3,639,263, 3,923,532, 4,006,779, 4,017,475, 4,019,995, 4,069,217, 4,088,640, 4,133,385, 4,181,652, 4,186,242, 4,196,777, 4,219,471, 4,236,579, 4,249,606, 4,250,088, 4,267,886, 4,269,270, 4,293,342 4,336,189, 4,344,487, 4,594,168, 4,666,522, 4,786,438, 5,032,164, 5,075,402, 5,286,412, 5,401,718, 5,446,133, 5,981,433, 6,420,602, and 7,238,645, which are incorporated herein by reference.

A preferred lignin compound is lignosulfonate. A preferred lignosulfonate is copper, zinc, calcium, sodium, potassium, ammonium, magnesium and/or aluminium lignosulfonate, preferably calcium, sodium, potassium or ammonium lignosulfonate, most preferred calcium lignosulfonate.

Said polycation is preferably selected from the group consisting of poly-L-lysine, epsilon-poly-L-lysine, poly-L-arginine, chitosan oligosaccharide, poly-allylamine and chitosan. Most preferably, said polycation comprises or is chitosan.

As used herein, the term “chitosan” refers to a linear polysaccharide composed of randomly distributed β-(1-4)-linked D-glucosamine (deacetylated unit) and N-acetyl-D-glucosamine (acetylated unit). Chitosan is produced by deacetylation of chitin. The term “chitosan” relates to chitosan, chitosan derivatives and mixtures of chitosan and chitosan derivatives.

The term chitosan relates to linear p-(1→4)-linked glucosamin and N-acetylglucosamin. It may be produced from chitin or its sodium salt (e.g. originating from shrimp) by treatment with aqueous sodium hydroxide at elevated temperatures, or by enzymatic treatment with, for example, a chitin deacetylase (EC 3.5.1.41). Further sources of chitin are fungi, including Basidiomycetes, Ascomycetes, and Phycomycetes, where it is a component of cell walls and structural membranes of mycelia, stalks, and spores. A most preferred chitosan is from fungi or derived from fungi.

Typically, deacetylation as determined by colloidal titration is from 50 to 99.9%, preferably from 70 to 99.8% and most preferably from 90 to 99.7%, as compared to chitin. Chitosan derivatives can be prepared by reactions at the amino group (e.g. by N-acylation, formation of N-alkylidene and N-arylidene derivatives, N-alkylation and N-arylation) or at hydroxy groups, as is known to the skilled person.

It was found that a polyanion, for example a lignin compound such as lignosulfonate, forms a stable polyelectrolyte complex with a polycation such as chitosan. A polyelectrolyte complex may comprise a mixture of two or more lignin compounds and/or a mixture of two or more chitosan polymers.

According to the invention, a polyelectrolyte complex that is formed between a polyanion, preferably xanthan gum, humate, alginate or lignosulfonate, most preferably lignosulfonate, and a polycation, preferably chitosan, in a relative amount of between 1:2 and 60:1 (w/w) improves the activity of the antimicrobial compound such as natamycin, resulting in a reduction of the amount of e.g. natamycin that is required to prevent development of soilborne pathogens in a soil.

The polyelectrolyte complex comprises a polyanion, such as a lignin-compound, xanthan gum, humate and alginate, and a polycation, such as chitosan or poly-allylamine, in a relative amount of between 1:2 and 60:1 (w/w), more preferred between 1:1 and 50:1, more preferred between 2:1 and 30:1, such as about 2:1, about 5:1, about 10:1; about 15:1, about 20:1, about 25:1 and about 30:1 (w/w). The relative amounts of a polyanion, preferably a lignin compound, and a polycation, preferably a chitosan, in a polyelectrolyte complex is most preferred about 5:1 (w/w).

The term “antimicrobial compound”, as is used herein, refers to a natural or chemical substance capable of inhibiting the growth of microorganisms, inhibiting the germination of spores of microorganisms and/or eliminating the microorganisms or their spores. An antimicrobial compound can be any compound active against moulds, yeasts, bacteria and/or viruses which is applied in agriculture, forestry products, food products, feed products, cosmetic products, pharmaceutical products and. Such an antimicrobial compound can be an antifungal, antibacterial or antivirus compound or a compound having a broader spectrum of activity against fungi and/or bacteria and/or viruses. Said antimicrobial compound is preferably an antifungal compound or antifungal microorganism, or a compound having a broad spectrum of activity against fungi and/or bacteria and/or viruses.

The at least one antimicrobial compound is or comprises an antimicrobial compound that can be applied in agriculture, horticulture or mushroom cultivation to combat soilborne pathogens, especially soilborne moulds. Said at least one antimicrobial compound is preferably an antifungal compound, an antibacterial compound and/or a antiviral compound.

The at least one antimicrobial compound preferably comprises one or more of chlorothalonil; thiophanate-methyl, fosetyl-Aluminium; flutonalil; iprodione; thiabendazole; a polyene compound such as natamycin; pencycuron; fluoxastrobine; imazalil; mefenoxam; polyram; metiram; maneb; azoxystrobin; tolclofos-methyl, fenamidone; etridiazole; propamocarb-hydrochloride; fluopyram; pencycuron; mancozeb; 2-phenylphenol; 8-hydroxyquinoline sulphate; acibenzolar-5-methyl; actinovate; aldimorph; amidoflumet; ampropylfos; ampropylfos-potassium; andoprim; anilazine; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carprop amid; carvone; chinomethionat; chlobenthiazone; chlorfenazole; chloroneb; chlozolinate; cis-1-(4-chlorophenyl)-2-(1H-1,2,4-triazol-1-yl)-cycloheptanol; clozylacon; a conazole fungicide such as, for example, (RS)-1-(β-allyloxy-2,4-dichlorophenethyl)imidazole (imazalil; Janssen Pharmaceutica NV, Belgium) and N-propyl-N-[2-(2,4,6-trichlorophenoxy)ethyl] imidazole-1-carboxamide (prochloraz); cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; famoxadone; fenapanil; fenfuram; fenhexamid; fenitropan; fenoxanil; fenpiclonil; fenpropidin; fenpropimorph; ferbam; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; flurprimidol; flusulfamide; folpet (N-(trichloromethylthio)phthalimide); fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprovalicarb; irumamycin; isoprothiolane; isovaledione; kasugamycin; kresoxim-methyl; meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-.alph-a.-(methoxymethylene)benzeneacetate; methyl 2-[2-[3-(4-chlorophenyl)-1-methyl-allylideneaminooxymethyl]phenyl]-3-meth-oxyacrylate; metominostrobin; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl)cyclopropanecarboxamide; N-butyl-8-(1,1-dimethylethyl)-1-oxaspiro[4.5]decan-3-amine, nitrothal-isopropyl; noviflumuron; ofurace; orysastrobin; oxadixyl; oxolinic acid; oxycarboxin; oxyfenthiin; penthiopyrad; phosdiphen; phthalide; picobenzamid; picoxystrobin; piperalin; polyoxins; polyoxorim; procymidone; propamocarb; propanosine-sodium; propineb; proquinazid; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicides such as for example thicyofen; thifluzamide; thiophanate-methyl; thiram; tiadinil; tioxymid; tolylfluanid; triazbutil; triazoxide; tricyclamide; tricyclazole; tridemorph; trifloxystrobin; validamycin A; vinclozolin; zineb; ziram; zoxamide; (2S)—N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxamide; 3,4,5-trichloro-2,6-pyridinedicarbonitrile; 3-[(3-bromo-6-fluoro-2-methyl-1H-indol-1-yl)sulphonyl]-N,N-dimethyl-1H-1,-2,4-triazole-1-sulphonamide; and copper salts such as Bordeaux mixture (CuSO4.3Cu(OH)2.3CaSO4); copper hydroxide; copper naphthenate; copper oxychloride ((CuCl2.3Cu(OH)2), tribasic copper sulphate (CuSO4.3Cu(OH)2); cufraneb; cuprous oxide; mancopper; and oxine-copper.

The term “polyene compound”, as used herein, refers to polyene macrolide antifungals that possess antifungal activity such as natamycin, lucensomycin, filipin, nystatin or amphotericin B, most preferred natamycin. Derivatives of a polyene fungicide, such as derivatives of natamycin, are also included. A preferred derivative is a salt or a solvate of a polyene fungicide and/or a modified form of a polyene fungicide such as e.g. different shaped crystal forms such as the needle-shaped crystal of natamycin described in U.S. Pat. No. 7,727,966.

A further preferred antimicrobial compound is a bactericide, for example bronopol, dichlorophen, nitrapyrin, nickel dimethyldithiocarbamate, kasugamycin, octhilinon, furancarboxylic acid, oxytetracyclin, probenazole, streptomycin, tecloftalam, and copper salts. Preferred bactericides include compounds such as copper salts (e.g. copper hydroxide, copper oxychloride, copper sulfate and Bordeaux mixture), sophorolipid which is a glycolipid that is produced by yeasts such as Candida bombicola, Candida apicola, and Wickerhamiella domercqiae and is composed of a dimeric sugar linked with a glycosidic bond to a hydroxyl fatty acid, streptomycin, the commercial product CITRICIDAL® (Bio/Chem Research) and validamycin. A most preferred bactericide is copper hydroxide. A composition of the invention may also comprise two or more bactericides.

Some of the indicated compounds have more than one activity. For example, copper salts (e.g. copper hydroxide) have bactericide and fungicide activities. The activities of the individual compounds are known to the skilled person. In addition, handbooks and websites (e.g. www.frac.info/frac) are available to determine the activity or activities of a compound.

A preferred antimicrobial compound according to the invention is a natural antimicrobial compound. The term natural antimicrobial compound comprises, pheromones, extracts from plants and/or animals, and other substances such as, for example, minerals. Preferred plant extracts are or comprise Sage extract (=extract of Salvia officinalis), extract of Reynoutria sachalinensis (Giant Knotweed), extract of Verticillium albo-atrum, extract of Bacillus thuringiensis subsp. Kurstaki, extract of Lecanicillium muscarium, laminarin, lactoperoxidase, azadirachtin, harpin, chitosan, nisin, pythium extract (and other fungal extracts).

Further preferred antimicrobial compounds include salicylic acid, castor oil, carvon, cedar oil, cinnamon and cinnamon oil, citric acid, citronella and citronella oil, cloves and clove oil, corn gluten meal, corn oil, cottonseed oil, eugenol, garlic and garlic oil, geraniol, geranium oil, lauryl sulphate, lemongrass oil, linseed oil, malic acid, mint and mint oil, peppermint and peppermint oil, 2-phenethyl propionate (2-phenylethyl propionate), sorbate such as potassium sorbate, putrescent whole egg solids, rosemary and rosemary oil, sesame and sesame oil, sodium chloride, sodium lauryl sulphate, soybean oil, thyme and thyme oil, white pepper, a sulfur-based compound, a copper-based compound, carbamates such as sodiumdimethyldithiocarbamaat, quaternairy ammonium compounds, benzyl-C12-16-alkyldimethyl, chlorides, sodium dichloroisocyanurate, calcium hypochlorite, ethanol, 2-propanol, didecyldimethylammonium chloride, ethylene oxide, sodium dichloroisocyanurate, trichloroisocyanic acid, peracetic acid, hydrogen peroxide, sodium-p-tolueensulfonchloramide, glutaraldehyde, N-(3-aminopropyl)-N-dodecylpropane-1,3-diamine, lactic acid, sodium hypochlorite, decanoic acid, octanoic acid, bronopol, imizalil, 1,2-benzisothiazole-3(2H)-on, dichlofluanide, propiconazole, permethrin, boric acid, flufenoxuron, 1,3-dichloro-5,5-dimethylhydantoine, 1,3-dichloro-5-ethyl-5-methylimidazolidine, 2,2-dibroom-2-cyanacetamide, bromo chloro-5,5-dimethylimidazolidine, difenacoum, difethialon, bromadiolon, flocoumafen, dichloorvos, diflubenzuron, cyromazin, bifenthrin, cyromazin, imidacloprid, deltamethrin, permethrin, tetramethrin, d-fenothrin, cyfluthrin, piperonylbutoxide, pyrethrine, alfa-cypermethrin, magnesiumfosfide, piperonylbutoxide, N,N-diethyl-m-toluamide, p-menthane-3,8-diol, cybutryne, cymoxanil, mancozeb, captan, linuron, prochloraz, glyfosate, nicosulfuron, folpet, chloridazon, milbemectin, metamitron, metsulfuron-methyl, gibberellic acid, azoxystrobin, spirotetramat, abamectin, indolyl butyric acid, teflubenzuron and/or rosemary oil, and/or mixtures thereof.

A preferred at least one antimicrobial compound is an antifungal compound. A preferred antifungal compound is selected from the following list: chlorothalonil, thiophanate-methyl, fosetyl-Aluminium, flutonalil, iprodione, thiabendazole, polyene fungicide such as natamycin, flutonalil, pencycuron, fluoxastrobine, imazalil, mefenoxam, polyram, methiram, maneb, azoxystrobin, tolclofos-methyl, fenamidone, etridiazole, propamocarb-hydrochloride, fluopyram, pencycuron and mancozeb.

The at least one antimicrobial compound preferably comprises at least two antimicrobial compounds including, for example, natamycine and chlorothalonil, natamycin and thiophanate-methyl, natamycin and fosetyl-Aluminium, natamycine and flutonalil, natamycine and iprodione, natamycine and thiabendazole, natamycine and flutonalil, natamycine and pencycuron, natamycine and fluoxastrobine, natamycine and imazalil, natamycine and mefenoxam, natamycine and polyram, natamycine and methiram, natamycine and maneb, natamycine and azoxystrobin, natamycine and tolclofos-methyl, natamycine and fenamidone, natamycine and etridiazole, natamycine and prop amocarb-hydrochloride, natamycine and fluopyram, natamycine and pencycuron and natamycine and mancozeb.

The effective amount of an antimicrobial compound together with the polyelectrolyte complex depends on the type of antimicrobial compound, the type of crop to be protected, the growth phase of the crop, environmental conditions, weather conditions such as rainfall and the type of soil to which a composition of this invention is added. Thus, the required concentration may differ depending on the efficacy of the individual antimicrobial compound in a certain application and the required level of protection, as is well known to the person skilled in the art and of course is recommended by the producer of the antimicrobial compound.

For example, in the case of natamycin: when applied in mushroom cultivation natamycin can be sprayed on the compost and/or casing to a final concentration of 1-200 mg of natamycin per m², preferably 1-100 mg of natamycin per m² and more preferably 3-30 mg of natamycin per m². The top layer of the compost and/or casing comprises 0.05-50 mg of natamycin per kg, preferably 0.2-40 mg of natamycin per kg and more preferably 0.3-30 mg of natamycin per kg.

Another example is fosetyl-aluminium (Aliette®). A typical use rate for ornamental crops is 360 grams per 380 liter of water to cover 36 m². In said application it is applied every 30 days with a maximum of tree applications per year.

A polyene fungicide natamycin has been used for almost 40 years as preservative in food industry, mainly on cheeses and dry fermented sausages. Natamycine is a very effective antifungal compound. Almost all fungi show high sensitivity towards natamycin and thus can be eliminated by using it.

Natamycin is a natural product derived from fermentation of Streptomyces natalensis. This antifungal compound is on the market for treatment of mushroom growth substrate under the trade name Zivion® (DSM Food Specialties). In U.S. Pat. No. 6,655,081 it is demonstrated that natamycin, when added to mushroom growth substrate, enhances the yield and speeds up the growth of commercial mushroom species such as Agaricus bisporus.

Natamycin is poorly soluble in water. In neutral aqueous systems its solubility will be around 30-40 ppm. In these conditions most natamycin is present in crystalline form. These crystals are quite stable under various conditions. Since only dissolved natamycin has antifungal activity, the crystals will not contribute to the antifungal activity of natamycin. Natamycin has a Minimal Inhibitory Concentration (MIC) of less than 10 ppm for most fungi, thus the dissolved fraction of 30-40 ppm should under normal conditions be sufficient to prevent development of fungi.

However, its low solubility and its limited diffusion from the crystals are real drawbacks in the efficacy and broader use of natamycin. In some cases its efficacy is simply not good enough or the required dosages are too high and thus economically not feasible.

In addition, the natamycin crystals are solid particles which easily flow away in the soil, e.g. when it is raining, or when watering the soil in case of greenhouses or mushroom cultivation. Undissolved natamycin, the crystals, will disappear in the soil without having contributed to combatting soilborne pathogenic moulds. Due to its low solubility, most of the natamycin will be present in a crystalline form, which makes it difficult to keep the average amount of dissolved natamycin at the effective concentration on the surface of the soil for longer periods of time.

An extra negative effect occurs in case of mushroom cultivation. Natamycin will flush away after watering from the surface of the mushroom substrate (compost) deeper into the compost and will interact with the mycelium of the commercial mushroom which is present in huge amount in the compost. Natamycin will be used up in high amounts by this mycelium and thus is not available anymore for eliminating mould pathogens on the surface of the growth substrate. Too low levels of dissolved natamycin on the surface of the growth substrate will result in development of pathogenic moulds and reduce the yield of the commercial mushrooms.

The term “soil”, as used herein, refers to the soil or soil substitute that pertains to and supports the growth and/or development of a plant or a tree or a fungus such as a mushroom. The term “soil” thus includes compost and compost tea. A preferred soil is a growth substrate, preferably a growth substrate for mushrooms, that is used in agriculture, horticulture or mushroom cultivation.

Agricultural soil is composed of solid particles of various sizes and various particles such as sand, silt, clay, rocks and organic matter such as compost. A fertile agricultural soil will be rich in nutrients and organic matter or can be enriched by using organic or synthetic fertilizers. The water content and absorbing characteristics of the soil will depend on its composition, the weather conditions and the climate. Also the soil acidity, the soil pH, may differ and will usually vary between 5.0 and 8.0.

A soil may be any material that physically supports the root system of a crop and/or provides nutrients to the root system. Said soil may be organic and/or synthetic soil. Examples of organic soil components are straw, peat, rice hulls, sawdust and pine bark. Synthetic soils are, for example, plastic beds or polymeric foams. Synthetic soils can also be inorganic mineral based such as stone wool, perlite, sand or gravel.

Mushroom growth substrate usually is a compost with on top a casing or top-layer but may be any growth substrate suitable for cultivation of mushrooms. Compost usually consist of straw (e.g. wheat, barley, rice or rye) horse and/or poultry manure, gypsum, minerals (e.g. calcium and nitrogen containing compounds), nutrients (e.g. vitamins or amino acids) and additional compositions such as woodships, hay, meal, flour and grid (e.g. potato protein, peanut meal, soy flour, corn gluten meal or bone meal).

The invention further provides a method for preventing development of soilborne pathogens in/on a soil comprising (a) providing an aqueous solution of a polyanion wherein the concentration of said polyanion is from 0.1-60 w/v %, preferably 1-25%, preferably about 10%, (b) providing a polycation, (c) mixing the polycation with the polyanion solution, thereby forming a precipitate, (d) crushing the formed precipitate to form an suspension, and (e) adding the suspension to the soil; whereby at least one antimicrobial compound is added to the product of one of steps (a)-(d) prior to the addition of the suspension to the soil.

Said method preferably comprises (a) providing an aqueous solution of a polyanion wherein the concentration of said polyanion is from 0.1-60 w/v %, preferably 1-25%, preferably about 10%, (b) providing an aqueous acidic solution of a polycation wherein the concentration of said polycation is from 0.1-30 w/v %, preferably 1-10%, preferably about 5%, and the pH is below pH=5.5, (c) mixing the polyanion solution with the polycation solution by adding the solution of a polyanion to the solution of a polycation or vice versa, thereby forming a precipitate, (d) crushing the formed precipitate to form an suspension, and (e) adding the suspension to the soil; whereby at least one antimicrobial compound is added to the product of one of steps (a)-(d) prior to the addition of the suspension to the soil.

A complex comprising an antimicrobial compound and a polyelectrolyte complex of a polyanion and a polycation, preferably whereby the polyanion and the polycation are present in a relative amount of between 1:2 and 60:1 (w/w), may be used for treating any soil used for growing crops in agriculture, horticulture or mushroom cultivation against soilborne pathogens. It is preferably used for combatting moulds.

The invention further provides a method for preventing development of soilborne pathogens in/on a soil, comprising a) providing an aqueous solution of a polyanion, wherein the concentration of said polyanion is from 0.1-60 w/v %, preferably 1-25%, preferably about 10%, b) providing a polycation, c) mixing the polycation with the polyanion solution by adding the polyanion solution to the polycation or vice versa, thereby forming a precipitate, d) crushing the formed precipitate to form an suspension, and e) adding the suspension to a soil; whereby at least one antimicrobial compound is added to the product of one of steps (a)-(d) prior to the addition of the suspension to the soil.

Said method preferably comprises a) providing an aqueous solution of a polyanion, wherein the concentration of said polyanion is from 0.1-60 w/v %, preferably 1-25%, preferably about 10%, b) providing an aqueous acidic solution of a polycation, wherein the concentration of said polycation is from 0.1-30 w/v %, preferably 1-10%, preferably about 5%, and the pH is below pH=5.5, c) mixing the polyanion solution with the polycation solution by adding the polyanion solution to the polycation solution or vice versa, thereby forming a precipitate, d) crushing the formed precipitate to form an suspension, and e) adding the suspension to a soil; whereby at least one antimicrobial compound is added to the product of one of steps (a)-(d) prior to the addition of the suspension to the soil.

The invention further provides a method of preventing, reducing and/or eliminating fungi, bacteria and/or viruses in/on a soil, comprising a) providing an aqueous solution of a polyanion, wherein the concentration of said polyanion is from 0.1-60 w/v %, preferably 1-25%, preferably about 10%, b) providing a polycation, c) mixing the polycation with the polyanion solution by adding the polyanion solution to the polycation or vice versa, thereby forming a precipitate, d) crushing the formed precipitate to form an suspension, and e) adding the suspension to the soil; whereby at least one antimicrobial compound is added to the product of one of steps (a)-(d) prior to the addition of the suspension to the soil.

Said method preferably comprises a) providing an aqueous solution of a polyanion, wherein the concentration of said polyanion is from 0.1-60 w/v %, preferably 1-25%, preferably about 10%, b) providing an aqueous acidic solution of a polycation, wherein the concentration of said polycation is from 0.1-30 w/v %, preferably 1-10%, preferably about 5%, and the pH is below pH=5.5, c) mixing the polyanion solution with the polycation solution by adding the polyanion solution to the polycation solution or vice versa, thereby forming a precipitate, d) crushing the formed precipitate to form an suspension, and e) adding the suspension to the soil; whereby at least one antimicrobial compound is added to the product of one of steps (a)-(d) prior to the addition of the suspension to the soil.

The terms “polyelectrolyte”, “polyanion”, “polycation”, “at least one antimicrobial compound” and “soil” are used in a method of the invention as defined herein before.

An aqueous solution of a polyanion, such as a lignin compound, is preferably prepared by dissolving the polyanion, such as a lignin compound, preferably lignosulfonate, in an aqueous solution, preferably water.

An aqueous solution of a polycation, preferably chitosan, is preferably prepared by solubilizing the polycation in an aqueous acidic solution comprising an acid such as, for example, lactate, hydrochloric acid, phosphorous acid and/or ascorbic acid. The amount of acid that is required to solubilize the polycation, preferably chitosan, depends on the polycation, as is known to the skilled person. For example, for solubilizing chitosan, in general, about 6 ml 37% HCl is required to obtain a solution of 10 gram chitosan in 1 liter in water. As an alternative, a polycation, preferably chitosan, is dissolved in an aqueous solution, preferably water, for example by gently shaking at 20-23° C. overnight, whereby a salt, preferably NaCl, is preferably added to the aqueous solution at a concentration between 1 mM and 1 M, preferably about 100 mM.

A polyanion solution, preferably a lignosulfonate, xanthan gum, humate, or alginate solution, is preferably added drop wise to a polycation, preferably a chitosan compound, or vice versa. If required, the pH is kept below 5.5 by the addition of an acid, preferably hydrochloric acid, lactic acid, ascorbic acid, phosphorous acid, nonanoic acid or acetic acid. The pH is more preferably kept below 5.0, more preferably below 4.5 during the formation of a polyelectrolyte complex. The temperature is preferably between 0° C. and 100° C., more preferred between 10° C. and 60° C., more preferred ambient temperature (15-25° C.). The resulting mixture is preferably stirred during formation of the polyelectrolyte complex and the polyelectrolyte complex is preferably allowed to settle overnight. Following settlement of the poly-electrolyte complex, a dispergent and/or a wetting agent is preferably added and the precipitate is crushed, preferably by milling for example in a bead mill, to provide a suspension comprising the polyelectrolyte complex of a polyanion and a polycation.

The relative amount of a polyanion and a polycation that are combined in step c) of a method according to the invention is between 1:2 and 60:1 (w/w), preferably between 2:1 and 30:1 (w/w), more preferred between about 5:1 and about 15:1 (w/w), even more preferred about 5:1. If required, an acid is added to the polycation-polyanion mixture to keep the pH of the mixture below pH=7, preferably below pH=5.5 in step c) of a method according to the invention. The final pH value of the resulting suspension comprising at least one antimicrobial compound may be adjusted to a pH value of between 2-12, more preferred between 4-9, most preferred between 5-8.

A suspension comprising a complex of at least one antimicrobial compound and a polyelectrolyte complex of a polyanion and a polycation may be diluted following the instructions of the producer, e.g. 2-1000 times, preferably about 200 times, preferably with water, to contain between 0.001 and 1% (w/v) of natamycin, prior to adding the suspension to the soil.

The suspension comprising the complex of at least one antimicrobial compound and a polyelectrolyte complex can be added directly to the soil according to any method known in the art e.g. by spraying it on the soil, mixing it through the soil, or by clipping the soil, or compounds which will be added to the soil, in the suspension. In addition, the suspension may also be added to an ingredient or to any composition applied to the soil, such as fertilizers, nutrient compositions and agents against other unwanted organisms such as insects, nematodes and/or mites.

A suspension comprising the complex of at least one antimicrobial compound and a polyelectrolyte complex may be applied at any suitable moment which of course will differ per crop and growth conditions such as the climate. It can e.g. be added to the soil before seeding or planting; before, during and/or after growth of the crop; and at different seasons such as before during and after the spring, summer, autumn and/or winter.

In case of mushroom cultivation a composition of the invention can be mixed through the soil (e.g. compost) or sprayed on the soil and/or top-layer (e.g. the casing) at any stage of the production process of the soil and/or at any stage of the mushroom growth cycle such as: before during or after fermentation of the compost; after spawing; after casing; together with one or more of the watering steps; before, during and after pinning; after harvesting the first and/or second harvest; or any combination of the above mentioned stages. A suspension comprising the complex of at least one antimicrobial compound and a polyelectrolyte complex can also be added to the spawn, the gypsum, the nutrient supplements and other additives usually applied in mushroom cultivation, or to any substance which is part of the mushroom growth substrate.

In an embodiment of the invention, a suspension comprising the complex of at least one antimicrobial compound and a polyelectrolyte complex can be used for treatment of soil. The suspension can be applied in/on any soil applied outside or inside such as in greenhouses. Said soil can be used for the production of any agricultural or horticultural product herein to be understood in a very broad sense and includes, but is not limited to edible crops such as cereals, vegetables, fruit, nuts/beans/seeds, herbs/spices and mushrooms; industrial crops; crops grown for feed; ornamental crops such as plants, flowers, bushes and trees.

Preferred examples of cereals are wheat, rice, oats, barley and maize.

Preferred examples of vegetables are lettuce, beans, peas, cabbage, carrots, onions, potatoes, seed-potatoes, tomatoes, peppers, cucumbers, asparagus, paprika, aubergines and pumpkins.

Preferred examples of fruit are apples, pears, cherries, peaches, apricots, plums, bananas, grapes, pineapples, papayas, mangos, kiwis, melons, oranges, grapefruits, lemons, mandarins, limes, strawberries, blackberries, currants, lychees, olives and avocados.

Preferred examples of nuts, beans and seeds are peanuts, ground-nuts, almonds, cashew nuts, pistachio nuts, coconuts, coffee, cocoa, sunflowers and rapeseed.

Preferred examples of mushrooms are edible mushrooms and mushrooms grown for pharmaceutical or industrial purposes. Examples of edible mushrooms are Agaricus bisporus (regular mushroom), Pleurotus ostreatus (oyster mushroom), Lentinus edotus (Shiitake mushroom), Pholiota aegerita (Poplar mushroom) and Lepista nuda (Blue stalk mushroom).

Preferred examples of industrial crops are sorghum, soya, palm oil, sugar beets, sugarcane, cotton, jute, tobacco, hops, rubber plants and tea.

Preferred examples of feed crops are fodder beet, maize and grass.

Preferred examples of ornamental crops are ornamental plants such as house plants and garden plants; cut flowers such as roses, chrysanthemums, dahlias, tulips, narcissus, gerberas and lilies; garden flowers such as cut flowers; flower plants such as crocuses, fuchsia's, violets, petunias, asters; garden trees/bushes such as conifers or Buddleia species.

A suspension comprising a complex of at least one antimicrobial compound and a polyelectrolyte complex of a polyanion and a polycation may additionally comprise optionally at least one compound selected from a compound enhancing the natural defense system of a plant, an insecticide, an acaricide, a sticking agent, a stabilizer, an antioxidant, a thickening agent, an anti-foam-forming agent, an UV-protectant, a spray oil, wax, an anti-freezing agent, a solubilizer, a chelating agent, and a flow additive, a thickening agent, a dispersing agent, and a wetting agent.

A preferred compound enhancing the natural defense system of a plant is phosphite. A preferred phosphite is a phosphite salt such as KH₂PO₃, K₂HPO₃, NaH₂PO₃, Na₂HPO₃, (NH₄)2HPO3, (NH₄)H₂PO₃, ethyl hydrogen phosphonate, phosphorous acid, and mixtures of these compounds. A mixture of KH₂PO₃ and K₂HPO₃ is suitably obtained by adding KOH or K2CO₃ to a KH2PO₃ composition at a final pH of 5-9.

A further preferred additional biocide is an insecticide and/or acaricide. Preferred insecticides include imidacloprid (commercial product: ADMIRE®, Bayer) Bacillus thuringiensis (commercial product: TUREX®, Certis USA), teflubenzuron (commercial product: NOMOLT®, BASF), pymetrozine (commercial product: PLENUM®, Syngenta) and acetamiprid (Commercial product: GAZELLE®, Certis Europe), ACTELLIC® Syngenta, Switserland), Pyrethroids (commercial product BAYGON® (Bayer), bifenazate (e.g. Uniroyal), dichlorvos (e.g. Amvac Chemical Corporation), imidacloprid (e.g. Bayer), fenamiphos (e.g. Mobay Chemical Corporation), rosemary oil, oxamyl (e.g. Dupont) and sulfur-based insecticides. A most preferred insecticide is pirimiphos-methyl (commercial product ACTELLIC®, Syngenta, Switserland). A composition of the invention may also comprise two or more insecticides.

Preferred acaricides include chlofentezine (commercial product: APOLLO®, Makhteshim), acequinocyl (commercial product: KAMEMYTE®, Arysta), spirodiclofen (commercial product: ENVIDOR®, Bayer CropScience), bifenazate (commercial product: FLORAMITE®, Certis Europe) and fenbutatinoxide (commercial product: TORQUE L®, BASF). A most preferred acaricide is spirodiclofen. A composition of the invention may also comprise two or more acaricides.

A further preferred insecticide/acaricide is a carbamate, for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiothcarb, thiofanox, trimethacarb, XMC, xylylcarb, triazamate; an organophosphate, for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-5-methyl, demeton-5-methylsulphon, dialifos, diazinon, dichlofenthion, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl 0-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion; a sodium channel modulator/voltage-dependent sodium channel blocker, such as a pyrethroid, for example acrinathrin, allethrin (d-cis-trans, d-trans), beta-cyfluthrin, bifenthrin, bioallethrin, bioallethrin-S cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (IR isomer), esfenvalerate, etofenprox, fenfluthrin, fenpropathrin, fenpyrithrin, fenvalerate, flubrocythrinate, flucythrinate, flufenprox, flumethrin, fluvalinate, flufenprox, gamma-cyhalothrin, imiprothrin, kadethrin, lambda-cyhalothrin, metofluthrin, permethrin (cis-, trans-), phenothrin (IR trans-isomer), prallethrin, profluthrin, protrifenbute, pyresmethrin, resmethrin, RU 15525, silafluofen, tau-fluvalinate, tefluthrin, terallethrin, tetramethrin (IR isomer), tralomethrin, transfluthrin, ZXI 8901; an oxadiazine, for example indoxacarb; an acetylcholine receptor agonists/antagonists; a chloronicotinyl, for example clothianidin, dinotefuran, imidacloprid, nitenpyram, nithiazine, thiacloprid, thiamethoxam; a nicotine such as bensultap, cartap; an organochlorine, for example camphechlor, chlordane, endosulfan, gamma-HCH, HCH, heptachlor, lindane, methoxychlor, a fiproles, for example acetoprole, ethiprole, fipronil, pyrafluprole, pyriprole, vaniliprole; a mectin, for example avermectin, emamectin, emamectin-benzoate, ivermectin, milbemycin; a juvenile hormone mimetics, for example diofenolan, epofenonane, fenoxycarb, hydroprene, kinoprene, methoprene, pyriproxifen, triprene; an ecdyson agonists/disruptors such as a diacylhydrazines, for example chromafenozide, halofenozide, methoxyfenozide, tebufenozide; benzoylureas, for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron an organotin, for example azocyclotin, cyhexatin, fenbutatin-oxide; a pyrrole, for example chlorfenapyr; a dinitrophenol, for example binapacyrl, dinobuton, dinocap, a tetronic acid, for example spirodiclofen, spiromesifen; a tetramic acid, for example spirotetramat and 3-(2,5-dimethylphenyl)-8-methoxy-2-oxo-1-azaspiro[4.5]dec-3-en-4-yl ethyl carbonate; a carboxamide, for example flonicamid; a benzoic acid dicarboxamide, for example flubendiamide; azadirachtin, a fumigant, for example aluminium phosphide, methyl bromide, sulphuryl fluoride; an antifeedant, for example cryolite, flonicamid, pymetrozine; a mite growth inhibitor, for example clofentezine, etoxazole, hexythiazox; amidoflumet, benclothiaz, benzoximate, bifenazate, bromopropylate, buprofezin, quinomethionate, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, and/or verbutin.

A sticking agent is preferably selected from latex based products like PROLONG® (Holland Fyto B. V., The Netherlands) and BOND® (Loveland Industries Ltd), pinolene/terpene based products like NU-FILM® (Hygrotech Saad) and SPRAY-FAST® (Mandops), long chain polysaccharides like gellan gum, guar gum, succinoglycan gum (RHEOZAN®; Rhodia) and xanthan gum, or a hydrated magnesium-aluminum silicate, for example attapulgite, (Attagel®; BASF). Alternatively, the sticking agent may be a polymer or co-polymer from a type of polymer such as polyacrylate and polyethylene e.g. NEOCRYL® (DSM, The Netherlands). A composition of the invention may also comprise two or more different sticking agents. A sticking agent is preferably present in an amount of between 0 to up to 20% (w/v), more preferred between 0.1 to up to 10% (w/v), more preferred between 1 to up to 5% (w/v), more preferred about 3% (w/v).

A stabilizer, when present, is preferably selected from xanthan gum, agar, succinoglycan gum (Rheozan), alginic acid, alginate, a hydrated magnesium-aluminum silicate, for example attapulgite, (Attagel®; BASF), calcium lactobionate, carrageenan, OptiXan-D®; gellan gum, and guar gum. A composition of the invention may also comprise two or more different stabilizing agents. A stabilizer is preferably present in an amount of between 0 to up to 10% (w/v), more preferred between 0.01 to up to 5% (w/v), more preferred between 0.05 to up to 0.5% (w/v), more preferred about 0.05% (w/v).

An antioxidant, when present, is preferably selected from amino acids (e.g. glycine, histidine, tyrosine, tryptophan) and their derivatives, imidazole (e.g. urocanic acid) and derivatives, vitamin C and derivatives (such as ascorbylpalmitate and ascorbyltetraisopalmitate, Mg-ascorbylphosphate, Na-ascorbylphosphate, ascorbyl-acetate), tocopherol and derivates (such as vitamin-E-acetate), mixtures of vitamin E, vitamin A and derivatives (vitamin-A-palmitate and -acetate) as well as coniferyl benzoate, rutinic acid and derivatives, α-glycosylrutin, ferulic acid, citric acid, furfurylideneglucitol, carnosine, butylhydroxytoluene, butylhydroxyanisole, and trihydroxybutyrophenone. A composition of the invention may also comprise two or more different antioxidants. An anti-oxidant is preferably present in an amount between 0 to of up to 20% (w/v), more preferred between 0.1 to up to 10% (w/v), more preferred between 1 to up to 5% (w/v), more preferred about 3% (w/v).

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

An anti-foam forming agent, when present, is preferably selected from polymethylsiloxane, simethicone octanol, and silicone oils. The composition of the invention may also comprise two or more different anti-foam forming agents. An anti-foam agent is preferably present in an amount of between 0 to up to 10% (w/v), more preferred between 0.05 to up to 5% (w/v), more preferred between 0.1 to up to 1% (w/v), more preferred about 0.05% (w/v).

An UV-protector or UV absorbent, when present, is preferably selected from sulphonated tannins, titaniumdioxide, lignosulfonates, and related compounds. An UV-protector is preferably present in amount of between 0.1 and 10% (w/v).

A composition according to the invention optionally further comprises an additional compound selected from a spray oil, for example, a mineral oil such as BANOLE®.

In addition, adispersing or wetting agent known to a skilled person such as, for example, Morwet® D425, lignin sulphonate, an alkylpolysaccharide, an styrene acrylic polymer, an acrylic co-polymer, and ethoxylated tristyrenephenol phosphate, for example polyethoxylated fosforic acid, and/or a wetting agent such as di-octylsuccinate, polyoxyethylene/polypropylene and tri-stearyl sulphonate/phosphate, is preferably present.

A wax, when present, is preferably a natural or synthetic wax selected from bee wax, carnauba wax, andelilla wax, ouricouri wax, sugarcane wax, retamo wax, Chinese wax, jojoba oil, paraffin wax, esparto wax, Montan wax, candelilla wax, whale spermaceti, lanolin, and ethylene glycol diesters or triesters of long-chain fatty acids (C18-C36). A wax is preferably present in an amount of between 0 to up to 10% (w/v), more preferred between 0.01 to up to 5% (w/v), more preferred between 0.05 to up to 0.5% (w/v), more preferred about 0.1% (w/v).

A solubilizer, when present, is preferably selected from surfactants of the anionic, cationic, non-ionic or amphoteric type. An example of an anionic surfactants is sodium lauryl sulfate. An example of a cationic surfactant is dodecyl ammonium chloride. Examples of hydrophilic nonionic surfactants are compounds known as Tween 20 and Tween 80. Examples of hydrophobic non-ionic surfactant are sorbitan monolaurate and sorbitan monostearate. Other known solubilizers are lecithin and polyvinylpyrrolidone.

An example of a preferred chelating agent is EDTA (ethylene diamin tetra acidic acid).

A dispergent, when present, is preferably one or more compounds selected from Morwet® D425, lignin sulphonate, an alkylpolysaccharide, an styrene acrylic polymer, an acrylic co-polymer, and ethoxylated tristyrenephenol phosphate, for example polyethoxylated fosforic acid. A dispergent is preferably present in an amount of between 0 to up to 10% (w/v), more preferred between 0.01 to up to 5% (w/v), more preferred between 0.02 to up to 1% (w/v), more preferred about 0.05% (w/v).

A wetting agent, when present, is preferably one or more compounds selected from di-octylsuccinate, polyoxyethylene/polypropylene and tri-stearyl sulphonate/phosphate. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

### EXAMPLES

### Example 1

### Preparation of CitoCal

10 gram of Chitosan was suspended in 885 mL water, 5 gram 37% HCl was added to completely dissolve the chitosan. Then 100 gram Calcium-Lignosulfonate was added portion wise to the solution. A milky solution appeared immediately and solids precipitated from the solution. When 40-50 grams of the Ca-LS was added a rise in viscosity was observed and the aqueous solution thickened and the polyelectrolyte clearly separated as a solid from the aqueous phase. By addition of the remaining 50 gr Ca-LS the aqueous phase became less viscous. The solid was settled overnight.

### Example 2

### Efficacy on Mushroom Growth Substrate

This example illustrates the improved efficacy of natamycin when applied in complex with a polyelectrolyte complex according to the present invention, on the growth of mushrooms.

Compost inoculated with spawn of Agaricus bisporus is prepared using well known methods.

Boxes of 50×50 cm are filed with the compost which are covered with a casing using well known methods. Directly after covering with the casing the boxes are sprayed with a 10× dilution of the compositions of table 1 and 2. The boxes are incubated and mushrooms are grown using well known methods.

The results show that the compositions of the present invention provide a higher yield of mushrooms compared to the activity of the active compound natamycin when applied individually.

TABLE 1
Formulations:

| | Treatment: | | | | | |
|---|---|---|---|---|---|---|
| | | #2 | #3 | #4 | #5 | #6 |
| | #1 | Adjuvants + | Adjuvants + | Adjuvants + | Adjuvants + | Adjuvants + |
| | Adjuvants | citocal | CitocalHumic | CitocalMorwet | oligo-Citocal | ai |
| Water | 664 | 664 | 664 | 664 | 664 | 664 |
| Ca-Lignosulfonate (g) | xx | 250 | | | 250 | xx |
| Potassium humate (g) | | | 100 | | | |
| Morwet (Akzo) (g) | | | | 83.3 | | |
| Chitosan (g) | xx | 10 | 10 | 10 | | xx |
| Oligomers of chitosan | | | | | 10 | |
| (g) | | | | | | |
| H3PO3 (g) | xx | 5 | 5 | 5 | 5 | xx |
| Sodiumdioctylsuccinate | 40 | 40 | 40 | 40 | 40 | 40 |
| (50%) (ml) | | | | | | |
| Sophorolipid (g) | 75 | 75 | 75 | 75 | 75 | 75 |
| Xanthan gum (2% in | 55 | 55 | 55 | 55 | 55 | 55 |
| H2O) (ml) | | | | | | |
| Polydimethylsiloxane | 1 | 1 | 1 | 1 | 1 | 1 |
| (g) | | | | | | |
| Natamycin (g) | xx | xx | xx | xx | xx | 10 |

| | Treatment: | | | |
|---|---|---|---|---|
| | #7 | #8 | #9 | #10 |
| | Adjuvants + | Adjuvants + | Adjuvants + | Adjuvants + |
| | citocal + | CitocalHumic + | CitocalMorwet + | oligo-Citocal + |
| | ai | ai | ai | ai |
| Water | 664 | 664 | 664 | 664 |
| Ca-Lignosulfonate (g) | 250 | | | 250 |
| Potassium humate (g) | | 100 | | |
| Morwet (Akzo) (g) | | | 83.3 | |
| Chitosan (g) | 10 | 10 | 10 | |
| Oligomers of chitosan | | | | 10 |
| (g) | | | | |
| H3PO3 (g) | 5 | 5 | 5 | 5 |
| Sodiumdioctylsuccinate | 40 | 40 | 40 | 40 |
| (50%) (ml) | | | | |
| Sophorolipid (g) | 75 | 75 | 75 | 75 |
| Xanthan gum (2% in | 55 | 55 | 55 | 55 |
| H2O) (ml) | | | | |
| Polydimethylsiloxane | 1 | 1 | 1 | 1 |
| (g) | | | | |
| Natamycin (g) | 10 | 10 | 10 | 10 |

All amounts are in grams. ai = active ingredient.

TABLE 2
Formulation

| | Formulation g/l | | | | | | |
|---|---|---|---|---|---|---|---|
| | | N2 | N3 | N4 | N6 | N7 | N8 |
| | N1 | Adjuvants + | Adjuvants + | Adjuvants + | Adjuvants + | Adjuvants + | Adjuvants + |
| | Adjuvants | CitoCal | Lysocal | AllyloCal | CHS:LS 2:1 | CHS:LS 1:2 | ai |
| Water | 751.0 | 751.0 | 751.0 | 751.0 | 751.0 | 751.0 | 771.0 |
| Ca-LS | | 50.0 | 50.0 | 50.0 | 5.0 | 20.0 | |
| Chitosan | | 10.0 | | | 10.0 | 10.0 | |
| Poly-e-Lysine | | | 10.0 | | | | |
| Poly-allylamine HCl | | | | 10.0 | | | |
| H3PO3 | | 5.0 | 5.0 | | 5.0 | 5.0 | |
| Sodiumdioctylsuccinate (50%) | 40.0 | 40.0 | 40.0 | 40.0 | 40.0 | 40.0 | 40.0 |
| Sophorolipid | 75.0 | 75.0 | 75.0 | 75.0 | 75.0 | 75.0 | 75.0 |
| Xanthan (2% in water) | 55.0 | 55.0 | 55.0 | 55.0 | 55.0 | 55.0 | 55.0 |
| Polydimethylsiloxane | 4.0 | 4.0 | 4.0 | 4.0 | 4.0 | 4.0 | 4.0 |
| Natamycine | | | | | | | 10.0 |
| Totals | 925.0 | 990.0 | 990.0 | 985.0 | 945.0 | 960.0 | 955.0 |

| | Formulation g/l | | | | |
|---|---|---|---|---|---|
| | N9 | N10 | N11 | N13 | N14 |
| | Adjuvants + | Adjuvants + | Adjuvants + | Adjuvants + | Adjuvants + |
| | CitoCal + ai | LysoCal + ai | AllyloCal + ai | CHS:LS 2:1 + ai | CHS:LS 1:2 + ai |
| Water | 751.0 | 751.0 | 751.0 | 751.0 | 751.0 |
| Ca-LS | 50.0 | 50.0 | 50.0 | 5.0 | 20.0 |
| Chitosan | 10.0 | | | 10.0 | 10.0 |
| Poly-e-Lysine | | 10.0 | | | |
| Poly-allylamine HCl | | | 10.0 | | |
| H3PO3 | 5.0 | 5.0 | | 5.0 | 5.0 |
| Sodiumdioctylsuccinate (50%) | 40.0 | 40.0 | 40.0 | 40.0 | 40.0 |
| Sophorolipid | 75.0 | 75.0 | 75.0 | 75.0 | 75.0 |
| Xanthan (2% in water) | 55.0 | 55.0 | 55.0 | 55.0 | 55.0 |
| Polydimethylsiloxane | 4.0 | 4.0 | 4.0 | 4.0 | 4.0 |
| Natamycine | 10.0 | 10.0 | 10.0 | 10.0 | 10.0 |
| Totals | 1000.0 | 1000.0 | 995.0 | 955.0 | 970.0 |

All amounts are in grams. ai = active ingredient.

### Example 3

### Polyelectrolyte Formulation Applied on Mushroom Growth Substrate

Naturally contaminated Phase III compost inoculated with mushroom spawn of the edible mushroom species Agaricus bisporus prepared using well known methods was obtained from a local Dutch grower

Formulations described in Table 3 were generated as described in Example 1 for CitoCal.

Boxes with a size of 30 (1)×25 (b)×10 (h) cm were filled with the Phase III compost and incubated for 4 days at a temperature of 21° C. in the dark. After this incubation period, the white mushroom mycelium was visible on the surface of the compost. The compost was covered with 3 cm of casing prepared using well known methods after which 30 ml of the different formulations was sprayed onto the casing. Each formulation was examined in duplicate. The next day, 200 ml of water was added to each box after which the boxes were incubated for 7 days at 21° C. in the dark allowing the mycelium to grow to the surface of the casing. After this period the white mushroom mycelium was visible at the surface of the casing. The boxes were further incubated in the dark at a temperature of 18° C.

Dehydration of the casing surface was prevented by spraying sufficient and equal amounts of water (circa 10 ml) onto the casing in each box every few days using well known methods. In addition to this spraying, 100 ml of water was added to each box after 21, 28, 33 and 43 days of incubation to stimulate mushroom formation. During a period of 46 days mushrooms were harvested every day; the total yield was determined by measuring the weight of the mushrooms.

The effect of the different treatments after 46 days of incubation on the total yield of mushrooms is presented in Table 3.

TABLE 3
Results of formulation on yield of mushroom

| | Total yield | Yield |
|---|---|---|
| | (gram/2 | increase |
| Composition | boxes) | (%) |
| Control | 364 | 0 |
| Natamycin (500 ppm) | 359 | −1.4 |
| CitoCal | 258 | −29.1 |
| CitoCal + Natamycin (500 ppm) | 403 | 10.7 |
| AllyloCal¹ | 377 | 3.6 |
| AllyloCal + Natamycin (500 ppm) | 419 | 15.1 |
| AllyloHum² | 347 | −4.7 |
| AllyloHum + Natamycin (500 ppm) | 415 | 14.0 |

¹poly-allylamine•HCl-calcium lignosulfonate complex
²poly-allylamine•HCl-potassium humate complex

These results clearly demonstrate that treatment with the compositions of this invention enhances the yield of mushrooms considerably to a yield increase from 10 up to 15%.

### Example 4

### Polyelectrolyte Formulation Against Pythium aphanidermatum in Chrysantum Soil

The AllyloCal polyelectrolyte complex (poly-allylamine.HCl-calcium lignosulfonate complex) was prepared using the same method as described in Examples 1 and 2.

Soil was artificially infected with Pythium aphanidermatum spores using well known methods. Crates of 40×60 cm each were filled with infected soil. Transplants of Chrysanthemum were planted after the artificial infection. Each plot consisted of 2 crates with each 15 plants (30 plants per plot). The trial was conducted in four replicates. A single application was done just after transplant by spraying the AllyloCal polyelectrolyte complex over the crop at 1000 l/ha. Immediately after the treatment, the products were rinsed in the soil with 3 liter of water per m². The applied concentration in the spray suspension was 1000 ppm of natamycin. After 10 days the numbers of healthy, diseased and dead plants were counted. The results are presented in Table 4.

TABLE 4
Effect of the different treatments at 10 days after infection (n = 120)

| | Healthy | Diseased | |
|---|---|---|---|
| | plants (%) | plants (%) | Dead plants (%) |
| Untreated | 52 | 41 | 7 |
| Natamycin control | 60 | 34 | 6 |
| AllyloCal control | 69 | 28 | 3 |
| AllyloCal + natamycin | 83 | 17 | 0 |

The trial was continued for another 34 days which did not provide any relevant changes to the results as presented.

At the end of the trial, after 44 days, the average plant height, the average plant weight and the rooting (in percentage of the bottom of the crates covered with roots) were measured.

The average height of the untreated control plants was 56.8 cm, of the natamycin control plants 59.9 cm, of the AllyloCal control plants 61.4 cm and of the plants treated with the composition of the invention 65.8 cm.

The average plant weight in grams of the untreated control plants was 41.5 grams, of the natamycin control plants 43.1 grams, of the AllyloCal control plants 45.0 grams and of the plants treated with the composition of the invention 50.1 grams.

The rooting in percentage at the bottom side of the crates of the untreated control plants was 8.6%, of the natamycin control plants 8.8%, of the AllyloCal control plants 10.6% and of the plants treated with the composition of the invention 13.4%. The improvement in percentage (untreated control set on zero) is presented in Table 5.

TABLE 5
Percentage improvement of plant height, plant weight and rooting
compared with the untreated plants (n = 120)

| | Plant | | |
|---|---|---|---|
| | height (%) | Plant weight (%) | Plant rooting (%) |
| Untreated | 0 | 0 | 0 |
| Natamycin control | 5.5 | 3.9 | 2.3 |
| AllyloCal control | 8.1 | 8.4 | 23.2 |
| AllyloCal + natamycin | 15.9 | 20.7 | 55.8 |

These results clearly demonstrate that a treatment with the composition of this invention improves the amount of healthy plants and reduces the amount of dead plants considerably. In addition the plant height, plant weight and plant rooting were considerably improved.

This example illustrates the improved efficacy towards the soilborne pathogenic mould Pythium aphanidermatum in Chrysantum soil of natamycin compositions prepared according to the invention comprising natamycin and an AllyloCal polyelectrolyte complex.

### Example 5

### Polyelectrolyte Formulation Against Fusarium oxysporum in Banana Soil

This example illustrates the improved efficacy of natamycin when applied in a polyelectrolyte complex according to the present invention towards the soilborne pathogenic mould Fusarium oxysporum f.sp. cubense (Foc) in banana soil.

Fusarium oxysporum f.sp. cubense (Foc) is a soilborne pathogen causing the destructive Panama disease in the growth of banana plants.

The AllyloHum polyelectrolyte complex was prepared using the same method as described in Examples 1 and 2, but using poly-allylamine and potassium humate to obtain the polyelectrolyte complex.

Soil for growing banana plants is prepared and inoculated with approximately 8×10⁸ chlamydospores of Fusarium oxysporum f.sp. cubense (Foc) per gram of soil using well-known methods. Directly after preparing the contaminated soil, the compositions are mixed through the soil.

The compositions which are examined are:

Natamycin in a polyelectrolyte complex (AllyloHum polyelectrolyte complex) at a final concentration of 100 and 1000 ppm in the soil;
Non-formulated natamycin at a final concentration of 100 and 1000 ppm in the soil;

The polyelectrolyte composition (AllyloHum polyelectrolyte complex) not containing the natamycin.

In addition, untreated and not-infected plants+ infected non-treated plants are included in the study as controls.

Banana plants of Cavendish cultivars obtained from a local grower in Israel with a length of approximately 50 cm are planted in pots containing 1 kg of the soil compositions described above. The banana plants are grown in a greenhouse under well-known conditions that are optimal for growing banana plants. Disease development in the greenhouse is monitored daily using well known protocols.

After 5-6 weeks disease development is observed. The results show that the compositions of the present invention provide a better protection of banana plants against the soilborne pathogen Fusarium oxysporum f.sp. cubense (Foc) compared to the activity of the active compound natamycin when applied individually.

1.-13. (canceled)

14. A soil comprising a complex of at least one antimicrobial compound and a polyelectrolyte complex of a polyanion and a polycation, whereby the polyanion and the polycation are present in a relative amount of between 1:2 and 60:1 (w/w).

15. The soil according to claim 14, wherein the polyanion is selected from the group consisting of a polyanion such as xanthan gum, alginate, a lignin compound such as lignosulfonate, pectin, carrageenan, humate, fulvate, angico gum, gum Kondagogu, sodium alkyl naphtalene sulfonate (Morwet), poly-γ-glutamic acid, maleic starch half-ester, carboxymethyl cellulose, chondroitin sulphate, dextran sulphate, hyaluronic acid and a synthetic polyanion such as poly(acrylic acid), polyphosphoric acid, and poly(L-lactide).

16. The soil according to claim 14, wherein the polyanion is a lignin compound such as lignosulfonate.

17. The soil according to claim 14, wherein the polycation is selected from the group consisting of poly-L-lysine, epsilon-poly-L-lysine, poly-L-arginine, poly-allylamine, chitosan oligosaccharide, and chitosan.

18. The soil according to claim 14, wherein the polycation is chitosan.

19. The soil according to claim 14, wherein the at least one antimicrobial compound is or comprises a fungicide.

20. The soil according to claim 14, wherein the at least one antimicrobial compound is or comprises a polyene antifungal compound, preferably natamycin.

21. A method for treatment of a soil comprising
a) providing an aqueous solution of a polyanion, wherein the concentration of said polyanion is from 0.1-60 w/v %,
b) providing a polycation,
c) mixing the polycation with the polyanion solution, thereby forming a precipitate,
d) crushing the formed precipitate to form an suspension, and
e) adding the suspension to the soil;
whereby at least one antimicrobial compound is added to the product of one of steps (a)-(d) prior to the addition of the suspension to the soil.

22. A method for preventing the development of pathogenic soilborne microorganisms, especially fungi, in and/or on a soil, comprising
a) providing an aqueous solution of a polyanion, wherein the concentration of said polyanion is from 0.1-60 w/v %,
b) providing a polycation,
c) mixing the polycation with the polyanion solution, thereby forming a precipitate,
d) crushing the formed precipitate to form an suspension, and
e) adding the suspension to the soil;
whereby at least one antimicrobial compound is added to the product of one of steps (a)-(d) prior to the addition of the suspension to the soil.

23. A method of preventing, reducing and/or eliminating the presence of fungi, bacteria and/or viruses in and/or on a soil, the method comprising
a) providing an aqueous solution of a polyanion, wherein the concentration of said polyanion is from 0.1-60 w/v %,
b) providing a polycation, c) mixing the polycation with the polyanion solution, thereby forming a precipitate,
d) crushing the formed precipitate to form an suspension, and
e) adding the suspension to the soil;
whereby at least one antimicrobial compound is added to the product of one of steps (a)-(d) prior to the addition of the suspension to the soil.

24. The soil according to claim 14, which is a growth substrate for mushrooms.

25. The method of claim 21, wherein the soil is a growth substrate for mushrooms.

26. The method of claim 22, wherein the soil is a growth substrate for mushrooms.

27. The method of claim 23, wherein the soil is a growth substrate for mushrooms.
